(19) United States
(12) Patent Application Publication
(10) Pub. No.: US 2002/0025039 A1
(43) Pub. Date: Feb. 28, 2002

(54) Recording method, producing method, playback method, apparatus, and information recording medium

(76) Inventors: Taku Kato, Kamakura-shi (JP); Naoki Endoh, Fuchu-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/941,687

(22) Filed: Aug. 30, 2001

(30) Foreign Application Priority Data
Aug. 30, 2000 (JP) 2000-260903

(51) Int. Cl. H04L 9/00; G06F 12/14

(52) U.S. Cl. 380/44; 713/193; 705/57

(57) ABSTRACT

Each embodiment of the present invention uses an information recording medium comprising an area A recording key management information and a read-only area B recording compressed data comprising compressed key management information. This information recording medium can verify validity of the key management information by confirming a match between the compressed data for the key management information read from the area A and the compressed data read from the read-only area B. Accordingly, it is possible to record the key management information by preventing unauthorized rewriting even on an information recording medium with a limited read-only area size.

### CROSS-REFERENCE TO RELATED APPLICATIONS

This application is based upon and claims the benefit of priority from the prior Japanese Patent Application No. 2000-260903, filed Aug. 30, 2000, the entire contents of which are incorporated herein by reference.

### BACKGROUND OF THE INVENTION

1. Field of the Invention

The present invention relates to a method of recording encrypted content data, a method of producing the same, a method of playing the same, an apparatus, and an information recording medium.

2. Description of the Related Art

Generally, an information recording medium records encrypted content data encrypted by using key information, key information for decrypting the encrypted content data, and key management information for the purpose of preventing an unauthorized copy, etc. Here, the key information and the key management information are recorded in a read-only area on the information recording medium for preventing unauthorized rewriting.

However, some information recording media such as DVD-RAM, etc. have limited read-only area sizes. On such an information recording medium, a data size for the key information and the key management information may exceed the read-only area size.

### BRIEF SUMMARY OF THE INVENTION

With respect to an information recording medium with the limited read-only area size, it is an object of the present invention to provide a recording method, a producing method, a playback method, an apparatus, and an information recording medium capable of recording key management information by preventing unauthorized rewriting.

An aspect of the present invention concerns an information recording medium having an area A which records the key management information and an area B which records compressed data for the key management information.

This information recording medium can verify validity of the key management information by confirming a match between the compressed data for the key management information read from the area A and the compressed data read from the read-only area B.

Accordingly, it is possible to record the key management information by preventing unauthorized rewriting even on an information recording medium with a limited read-only area size.

As another aspect of the present invention, the above-mentioned information recording medium may be used for a recording method, a producing method, a playback method, a recording apparatus, and a playback apparatus.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic diagram showing an information recording area on a recording medium according to a first embodiment of the present invention;

FIG. 2 is a schematic diagram showing a procedure for recording copyrighted content on the recording medium according to the first embodiment;

FIG. 3 is a schematic diagram showing a procedure for reading copyrighted content from the recording medium according to the first embodiment;

FIG. 4 is a schematic diagram showing an information recording area on a recording medium according to a second embodiment of the present invention;

FIG. 5 is a schematic diagram showing a procedure for recording copyrighted content on the recording medium according to the second embodiment;

FIG. 6 is a schematic diagram showing a procedure for reading copyrighted content from the recording medium according to the second embodiment;

FIG. 7 is a schematic diagram showing an information recording area on a recording medium according to a third embodiment of the present invention;

FIG. 8 is a schematic diagram showing a procedure for recording copyrighted content on the recording medium according to the third embodiment; and

FIG. 9 is a schematic diagram showing a procedure for reading copyrighted content from the recording medium according to the third embodiment.

### DETAILED DESCRIPTION OF THE INVENTION

Embodiments of the present invention will be described in further detail with reference to the accompanying drawings.

(First Embodiment)

The following describes the first embodiment by using an example of a recording medium having a writable area and a read-only area. This recording medium is hereafter referred to as a recording DVD (Digital Versatile Disc) or just as a disc.

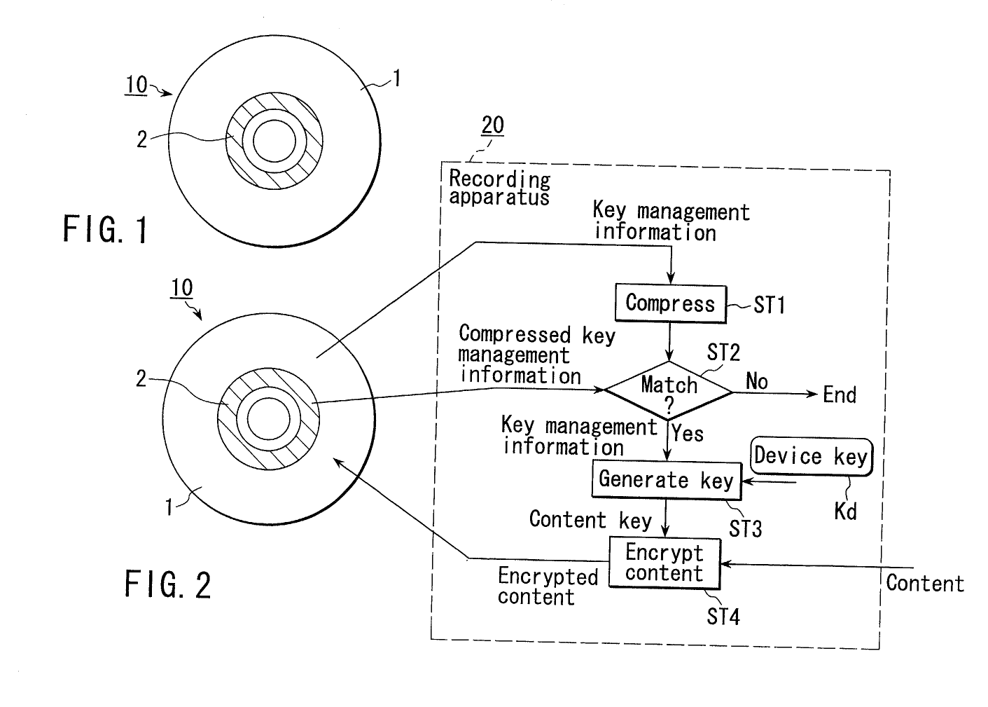

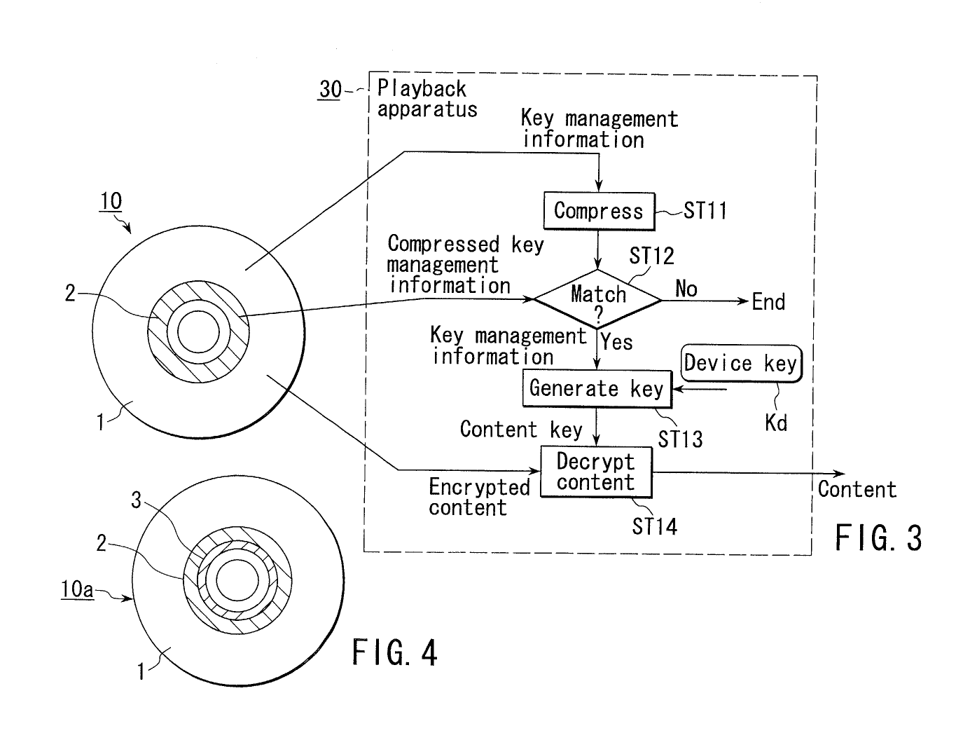

FIG. 1 is a schematic diagram showing an information recording area on a disc according to the first embodiment of the present invention. This disc 10 comprises a read-only area 2 and a writable area 1. The read-only area 2 is annularly formed around the center of the disc. The writable area 1 is formed on the almost entire surface outside the read-only area 2.

Corresponding to area sizes, the writable area 1 provides a much larger storage capacity than the read-only area 2. The writable area 1 records key management information predetermined when the disc 10 is produced. The writable area 1 can also record encrypted content data in addition to the key management information. The (encrypted) content data is encrypted by using key management information in a decipherable manner. As will be described later, the encrypted content data may be recorded by a user or a disc creator when the disc is created. The key information (content key) for decrypting the encrypted content data is embedded in the key management information.

Corresponding to area sizes, the read-only area 2 provides a much smaller storage capacity than the writable area 1. When the disc 10 is produced, the read-only area 2 records the compressed data comprising the compressed key management information as mentioned above.

A creator of the disc 10 records the predetermined key management information on the writable area 1. Further, the creator compresses the relevant key management information using a specified function and records resulting compressed data (compressed key management information) on the read-only area 2. The disc 10 is thus created. For example, a hash function, etc. can be used for compression.

FIG. 2 shows how a user's recording apparatus 20 records a copyrighted content on the disc 10. The following steps ST1 to ST4 describe the procedure of this recording method. The steps ST1 to ST4 are executed by a compression circuit, a comparison circuit, a key generation circuit, or an encryption recording circuit in the recording apparatus 20.

(ST1) The recording apparatus 20 reads the key management information from the writable area 1 on the disc 10. The compression circuit compresses this key management information by using a specified compression function to generate compressed data.

(ST2) The recording apparatus 20 reads compressed data (precompressed key management information) from the read-only area 2 of the disc 10. The comparison circuit compares this compressed data with the compressed data generated at step ST1. When they differ from each other as a comparison result, the recording process terminates.

(ST3) The recording apparatus 20 allows the key generation circuit to generate a content key from the key management information by using a device key Kd already given to itself.

(ST4) The recording apparatus 20 allows the encryption recording circuit to encrypt the input content data by using the content key generated at step ST3. The resulting encrypted content data is recorded in the writable area 1 on the disc 10.

The following steps ST11 to ST14 describe means for playing the copyrighted content recorded on the disc 10 according to the above-mentioned procedure. The steps ST11 to ST14 are executed by a compression circuit, a comparison circuit, a key generation circuit, or a decryption circuit in a playback apparatus 30.

(ST11) The playback apparatus 30 reads the key management information from the writable area 1 on the disc 10. The compression circuit compresses this key management information by using a predetermined compression function to generate compressed data.

(ST12) The playback apparatus 30 reads compressed data from the read-only area of the disc 10. The comparison circuit compares this compressed data with the compressed data generated at step ST11. When they differ from each other as a comparison result, the playback process terminates.

(ST13) The playback apparatus 30 allows the key generation circuit to generate a content key from the key management information by using a device key Kd already given to itself.

(ST14) The playback apparatus 30 reads the encrypted content data from the writable area on the disc 10. The decryption circuit decrypts the encrypted content data using the content key generated at step ST13. The resulting content data is output according to a specified method.

The recording apparatus 20 and the playback apparatus 30 need not necessarily be implemented on different apparatuses, but on a single apparatus.

As mentioned above, this embodiment uses the information recording medium 10 provided with the writable area 1 recording the key management information and the read-only area 2 recording the compressed data comprising the compressed key management information. This information recording medium 10 can verify validity of the key management information by confirming a match between the compressed data for the key management information read from the writable area 1 and the compressed data read from the read-only area 2.

Accordingly, it is possible to record a large amount of key management information by preventing unauthorized rewriting even on an information recording medium with a limited usable read-only area size smaller than the key management information size.

Since the location of the read-only area 2 is specified, this is an advantage that compressed data cannot be copied. When the compressed data and the key management information are copied illegally, for example, it is possible to detect during recording or playback that compressed data is found in the area 1 which differs from the correct read-only area 2. Accordingly, it is possible to prevent recording or playback of an unauthorized copy.

According to this embodiment, a user can delete or rewrite the key management information because this information is written in the writable area 1. Illegally deleting or rewriting the key management information disables accurate recording or playback of copyrighted contents, disadvantaging the user. When the key management information is accidentally deleted or rewritten due to an inadvertent operation, etc., a disc creator may put the key management information online, say, on an Internet Web site so that users can correct the key management information.

(Second Embodiment)

The following describes the second embodiment by using an example of a recording medium (hereafter referred to as a recording DVD or just as a disc) having a writable area, and first and second read-only areas. The second read-only area uses a write method different from that for the other two areas.

FIG. 4 is a schematic diagram showing an information recording area on a disc according to the second embodiment of the present invention. A disc 10a comprises a second read-only area 3, a first read-only area 2, and a writable area 1. The second read-only area 3 is annularly formed around the center of the disc. The first read-only area 2 is annularly formed outside the second read-only area 3. The writable area 1 is formed on the almost entire surface outside the first read-only area 2.

The second read-only area 3 corresponds to, say, the Burst Cutting Area of DVD-R (Recordable), DVD-RW (Re-recordable), and DVD-RAM (Rewritable).

The second read-only area 3 uses a write method different from that for the other areas 1 and 2. During a read operation, a read apparatus can read from the second read-only area 3 completely independent of the other areas 1 and 2.

The second read-only area 3 is written through the use of means which is not installed on a commercially available writing apparatus, making unauthorized writing very difficult.

Since the second read-only area 3 makes a write operation difficult, writing the key management information is difficult. This area is configured to record only small-size data such as compressed data for the key management information, etc.

By contrast, the first read-only area 2 allows an unauthorized user to relatively easily write to an unrecorded disc in the manufacturing process by using, say, a remodeled writing apparatus.

Namely, a creator of the disc 10 writes predetermined key management information to the first read-only area 2 and compresses the relevant key management information using a predetermined function. The creator writes the resulting compressed data (compressed key management information) to the second read-only area 3 according to a write method different from that for the first read-only area 2. The disc 10a is thus created.

The key management information or the compressed data not only may be provided by the disc creator, but also may be licensed from a given licensing organization.

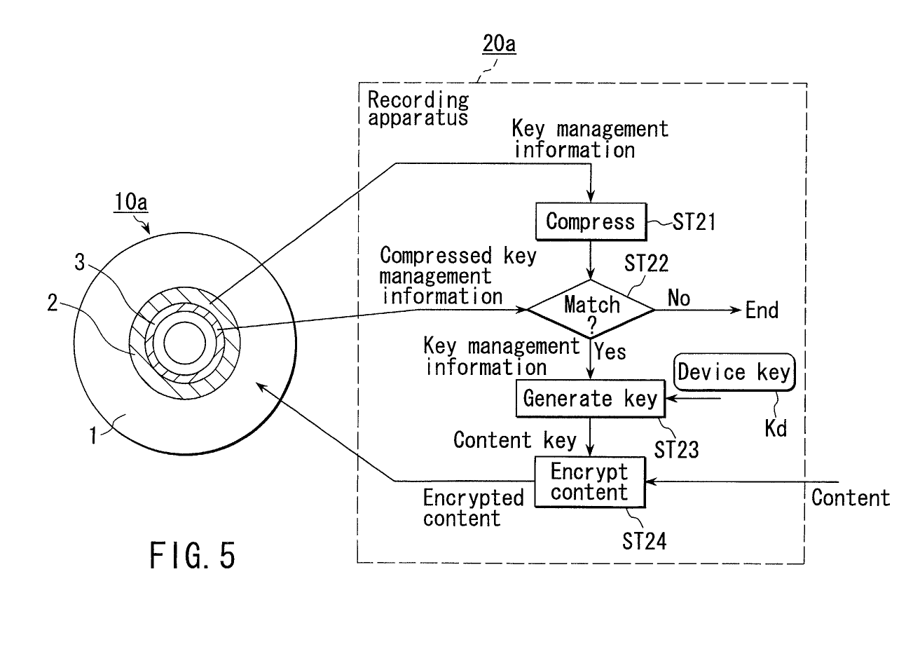

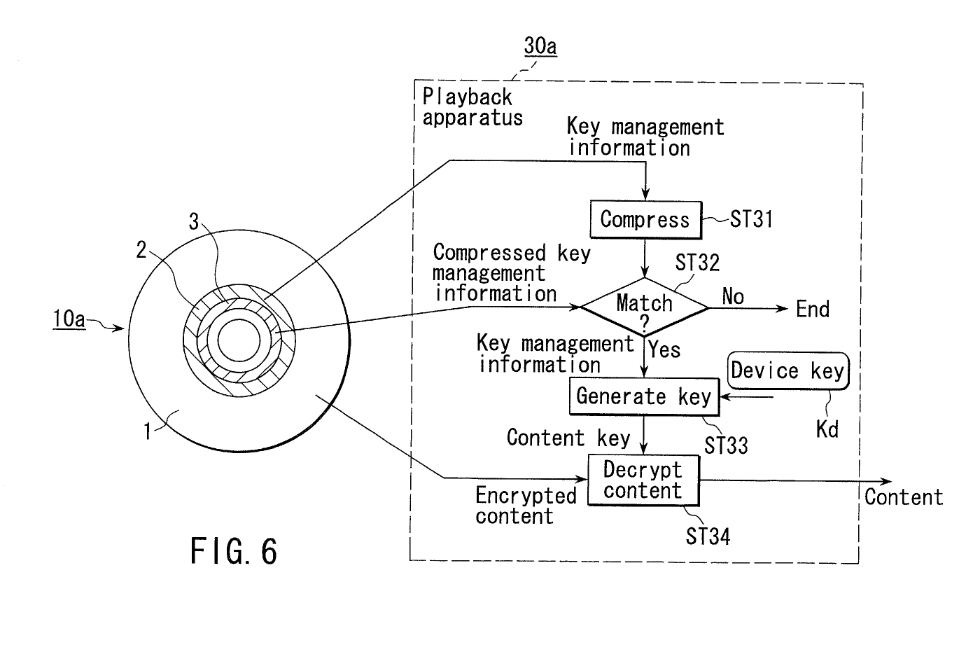

FIG. 5 depicts how a user's recording apparatus 20a records a copyrighted content on the disc 10a. The following steps ST21 to ST24 describe the procedure of this recording method. The steps ST21 to ST24 are executed by a compression circuit, a comparison circuit, a key generation circuit, or an encryption recording circuit in the recording apparatus 20a.

(ST21) The recording apparatus 20a reads the key management information recorded on the first read-only area 2 on the disc 10a. The compression circuit compresses this key management information by using a predetermined compression function to generate compressed data.

(ST22) The recording apparatus 20a reads compressed data (precompressed key management information) from the second read-only area 3 of the disc 10a. The comparison circuit compares this compressed data with the compressed data generated at step ST21. When they differ from each other as a comparison result, the recording process terminates.

(ST23) The recording apparatus 20a allows the key generation circuit to generate a content key from the key management information by using a device key Kd already given to itself.

(ST24) The recording apparatus 20a allows the encryption recording circuit to encrypt the input content data by using the content key generated at step ST23. The resulting encrypted content data is recorded in the writable area 1 on the disc 10a.

The following steps ST31 to ST34 describe means for playing the copyrighted content recorded on the disc 10a according to the above-mentioned procedure. The steps ST31 to ST34 are executed by a compression circuit, a comparison circuit, a key generation circuit, or a decryption circuit in a playback apparatus 30a.

(ST31) The playback apparatus 30a reads the key management information from the first read-only area 2 on the disc 10a. The compression circuit compresses this key management information by using a predetermined compression function to generate compressed data.

(ST32) The playback apparatus 30a reads the compressed data from the second read-only area 3 of the disc 10a. The comparison circuit compares this compressed data with the compressed data generated at step ST31. When they differ from each other as a comparison result, the playback process terminates.

(ST33) The playback apparatus 30a allows the key generation circuit to generate a content key from the key management information by using a device key Kd already given to itself.

(ST34) The playback apparatus 30a reads the encrypted content data from the writable area 1 on the disc 10a. The decryption circuit decrypts the encrypted content data using the content key generated at step ST33. The content data is output according to a specified method.

As mentioned above, the recording apparatus 20a and the playback apparatus 30a need not necessarily be implemented on different apparatuses, but on a single apparatus.

As mentioned above, this embodiment uses the information recording medium 10a provided with the first read-only area 2 recording the key management information and the read-only area 3 recording the compressed data comprising the compressed key management information. This information recording medium 10a can verify validity of the key management information by confirming a match between the compressed data for the key management information read from the first read-only area 2 and the compressed data read from the second read-only area 3.

Accordingly, it is possible to record a large amount of key management information by preventing unauthorized rewriting even on an information recording medium with a limited smaller size for the second read-only area 3 than the key management information size.

Further, the second read-only area 3 and the writable area 1 are arranged at remarkably different positions, apart from each other for the width of the first read-only area 2. Accordingly, if compressed data is copied to the writable area 1, it is possible to avoid erratically recognizing the compressed data on the second read-only area 3 during recording or playback. It is possible to detect that the compressed data apparently exists at a different location. Therefore, it is possible to more reliably prevent recording or playback due to an unauthorized copy.

It may be preferable to provide a configuration which records or plays encrypted content data from an SD memory card, a smart card (IC card), etc. as well as discs 10 and 10a. In this configuration, a controller for the SD memory card or the smart card just needs to execute each step. When the SD memory card or the smart card is used instead of the disc 10a for the second embodiment, there may be alternatives to the Burst Cutting Area of the disc 10a. For example, it may be preferable to use an area in which the controller strictly manages read/write operations for preventing an unauthorized access. Further, an ROM area for recording compressed data may be separately provided in the SD memory card or the smart card.

(Third Embodiment)

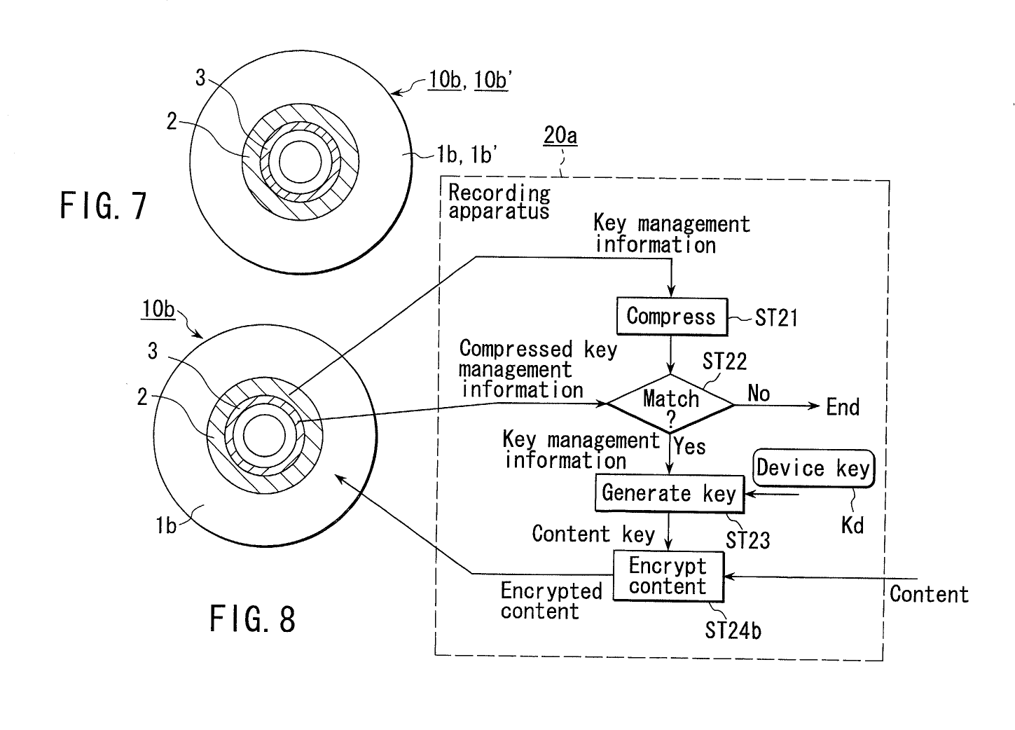

FIG. 7 is a schematic diagram showing an information recording area on a disc according to the third embodiment of the present invention. Therefore, the same parts or components in FIG. 4 are depicted by the same reference numerals and a detailed description is omitted. Different parts or components are chiefly described here.

Namely, the third embodiment is a modification of the second embodiment. The third embodiment uses discs 10b and 10b′ provided with third read-only areas 1b and 1b′ in addition to the writable area 1 in FIG. 4.

The discs 10b and 10′ are read-only information recording media like DVD-ROM, etc. The disc 10b is a master on which a factory-owned recording apparatus recorded information. The disc 10b′ is replicated from the master by means of a stamper, etc. A user-owned playback apparatus plays contents recorded on the disc 10b′.

Encrypted content data is written to the third read-only area 1b on the disc 10b only once when the disc 10b is manufactured. After the encrypted content data is written, the third read-only area 1b becomes write-inhibited and is used as a read-only storage area.

The third read-only area 1b′ on the disc 10b′ is formed by replicating the disc 10b. On this area, encrypted content data is written for read-only purpose.

FIG. 8 shows how a factory-owned recording apparatus 20a records a copyrighted content on the disc 10b. Steps ST21 to ST24b describe a procedure for this recording method. However, a description of steps ST21 to ST23 is omitted because these steps are same as those mentioned above. (ST24b) The recording apparatus 20a allows the encryption recording circuit to encrypt the input content data by using the content key generated at step ST23. The resulting encrypted content data is recorded in the third read-only area 1b on the disc 10b.

The disc 10b is produced by using the above-mentioned procedure. Thereafter, the disc 10b is replicated for mass-producing the disc 10b′.

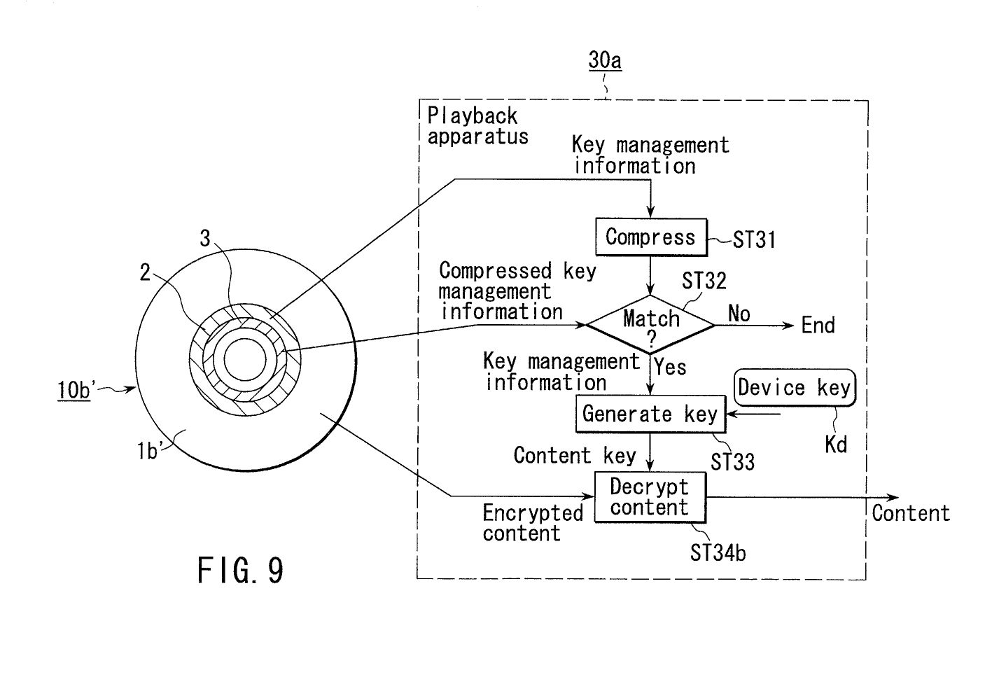

Steps ST31 to ST34b describe means for playing a copyrighted content recorded on the mass-produced disc 10b′ with reference to FIG. 9. However, a description of steps ST31 to ST33 is omitted because these steps are same as those mentioned above.

(ST34) The playback apparatus 30a reads the encrypted content data from the third read-only area 1b′ on the disc 10b′. The decryption circuit decrypts the encrypted content data using the content key generated at step ST33. The content data is output according to a specified method.

As mentioned above, the third embodiment can provide effects equivalent to those for the second embodiment if the third embodiment is modified so that the read-only discs 10b and 10b′ are used instead of the writable disc 10a according to the second embodiment.

The recording and playback techniques described for the above-mentioned embodiments are available as a computer-executable program. This program can be stored on a program storage medium for distribution. Such a storage medium should store programs in any storage format and be computer-readable. Available storage media include a magnetic disk (floppy disk, hard disk, etc.), an optical disk (CD-ROM, DVD, etc.), a magnet-optical disk (MO), semiconductor memory, etc.

Based on instructions of the program installed on a computer from the program storage medium, it may be preferable to execute part of each process for implementing the embodiments by using an OS (operating system), MW (middleware) such as database management software, network software, etc. executing on the computer.

The program storage media include not only a medium independent of the computer, but also a program storage medium which stores or temporarily stores a downloaded program transferred via a LAN, the Internet, etc.

The number of program storage media is not limited to one. It may be preferable to use a plurality of program storage media for executing processes of the embodiments. The program storage medium may be available in any configuration.

The computer according to the present invention may be a stand-alone apparatus such as a personal computer, a computer system comprising a plurality of networked computers, etc. on the condition that the computer needs to execute each process in the embodiments based on a program stored in the program storage medium.

The computer according to the present invention is not limited to a personal computer, but generically refers to a circuit or an apparatus capable of implementing functions of the present invention by means of a program. Accordingly, the computer includes information processing equipment such as a processor, a microcomputer, etc.

The present invention is not limited to the abovementioned embodiments. It is further understood by those skilled in the art that various changes and modifications may be made in the present invention without departing from the spirit and scope thereof. The embodiments may be available in any possible combinations. In this case, combined effects are provided. The above-mentioned embodiments include inventions at various stages. Various inventions can be extracted through an appropriate combination of a plurality of constituent requirements disclosed. For example, when an invention is extracted by omitting some of all the constituent requirements presented in the embodiments, the omitted requirements are appropriately supplemented by known conventional technologies.

Furthermore, the present invention may be embodied in various modifications without departing from the spirit and scope of the invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method of recording information on an information recording medium, comprising:
preparing an information recording medium having a first read-only area recording a specified key management information, a second read-only area recording compressed data comprising said key management information compressed with a specified function according to a recording system different from that for said first read-only area, and a writable area for recording, in a writable manner, encrypted content data resulting from encryption based on said key management information;
reading key management information from said first read-only area on said prepared information recording medium and converting said key management information to compressed data by using a specified function;
reading compressed data from said second read-only area and comparing this compressed data with the compressed data obtained at said conversion;
when both match as a result of said comparison, generating a content key from said key management information by using its own device key; and
encrypting input content data by using said generated content key and recording the obtained encrypted content data on said writable area.

2. A method of producing an information recording medium, comprising:
preparing an information recording medium having a first read-only area recording a specified key management information, a second read-only area recording compressed data comprising said key management information compressed with a specified function according to a recording system different from that for said first read-only area, and a writable area for recording, in a writable manner, encrypted content data resulting from encryption based on said key management information;
reading key management information from said first read-only area on said prepared information recording medium and converting said key management information to compressed data by using a specified function;
reading compressed data from said second read-only area and comparing this compressed data with the compressed data obtained at said conversion;
when both match as a result of said comparison, generating a content key from said key management information by using its own device key; and
encrypting input content data by using said generated content key and recording the obtained encrypted content data on said writable area.

3. A method of playing information from an information recording medium, comprising:
preparing an information recording medium having a first read-only area recording a specified key management information, a second read-only area recording compressed data comprising said key management information compressed with a specified function according to a recording system different from that for said first read-only area, and a writable area recording, in a writable manner, encrypted content data resulting from encryption based on said key management information;
reading key management information from said first read-only area on said information recording medium and converting said key management information to compressed data by using a specified function;
reading compressed data from said second read-only area and comparing this compressed data with the compressed data obtained at said conversion;
when both match as a result of said comparison, generating a content key from said key management information by using its own device key; and
reading said encrypted content data from said writable area, decrypting said encrypted content data by using said generated content key, and outputting obtained content data.

4. An information recording medium comprising:
a first read-only area recording specified key management information;
a second read-only area recording compressed data comprising said key management information compressed with a specified function according to a recording system different from that for said first read-only area; and
a writable area for recording, in a writable manner, encrypted content data resulting from encryption based on said key management information.

5. The information recording medium according to claim 4, wherein
said first read-only area is formed between said second read-only area and said writable area.

6. The recording apparatus for recording information on the information recording medium described in claim 4, comprising:
a compression circuit configured to convert key management information read from a first read-only area on said information recording medium to compressed data by using a specified function;
a comparison circuit configured to compare compressed data read from a second read-only area on said information recording medium with compressed data obtained in said compression circuit;
a key generation circuit configured to generate a content key from said key management information by using its own device key when a match is found as a result of comparison by said comparison circuit; and
an encryption recording circuit configured to encrypt input content data by using a content key generated in said key generation circuit and record obtained encrypted content data onto said writable area.

7. The playback apparatus for playing information from the information recording medium described in claim 4, comprising:
a compression circuit configured to convert key management information read from a first read-only area on said information recording medium to compressed data by using a specified function;
a comparison circuit configured to compare compressed data read from a second read-only area on said information recording medium with compressed data obtained in said compression circuit;
a key generation circuit configured to generate a content key from said key management information by using its own device key when a match is found as a result of comparison by said comparison circuit; and
a decryption circuit configured to decrypt encrypted content data read from a writable area on said information recording medium by using a content key generated in said key generation circuit and output obtained content data.

8. An information recording medium comprising:
a first read-only area recording specified key management information, wherein said key management information, after it is read, is used as compressed data converted with a specified function and is compared to compressed data in said second read-only area.
a second read-only area recording compressed data comprising said key management information compressed with a specified function according to a recording system different from that for said first read-only area; and
a writable area for recording, in a writable manner, encrypted data to be recorded based on said key management information when said comparison results in a match.

9. A method of recording information on an information recording medium, comprising:
preparing an information recording medium having a writable area for recording, in a writable manner, specified key management information and encrypted content data and a read-only area recording compressed data comprising said key management information compressed with a specified function according to a recording system different from that for said writable area;
reading key management information from said writable area on said prepared information recording medium and converting said key management information to compressed data by using a specified function;
reading compressed data from said read-only area and comparing this compressed data with the compressed data obtained at said conversion;
when both match as a result of said comparison, generating a content key from key management information by using its own device key; and
encrypting input content data by using said generated content key and recording the obtained encrypted content data on said writable area.

10. A method of producing an information recording medium, comprising:
preparing an information recording medium having a writable area for recording, in a writable manner, specified key management information and encrypted content data and a read-only area recording compressed data comprising said key management information compressed with a specified function according to a recording system different from that for said writable area;
reading key management information from said writable area on said prepared information recording medium and converting said key management information to compressed data by using a specified function;
reading compressed data from said read-only area and comparing this compressed data with the compressed data obtained at said conversion;
when both match as a result of said comparison, generating a content key from key management information by using its own device key; and
encrypting input content data by using said generated content key and recording the obtained encrypted content data on said writable area.

11. A method of playing information from an information recording medium, comprising:
preparing an information recording medium having a writable area for recording, in a writable manner, specified key management information and encrypted content data and a read-only area recording compressed data comprising said key management information compressed with a specified function according to a recording system different from that for said writable area;
reading key management information from said writable area on said prepared information recording medium and converting said key management information to compressed data by using a specified function;
reading compressed data from said read-only area and comparing this compressed data with the compressed data obtained at said compression step;
when both match as a result of said comparison, generating a content key from key management information by using its own device key; and
reading said encrypted content data from a writable area on said information recording medium, decrypting said encrypted content data by using said generated content key, and outputting obtained content data.

12. A method of recording information on an information recording medium, comprising:
preparing an information recording medium having a first read-only area recording a specified key management information, a second read-only area recording compressed data comprising said key management information compressed with a specified function according to a recording system different from that for said first read-only area, and a third read-only area capable of only once recording encrypted content data resulting from encryption based on said key management information;
reading key management information from said first read-only area on said prepared information recording medium and converting said key management information to compressed data by using a specified function;
reading compressed data from said second read-only area and comparing this compressed data with the compressed data obtained at said conversion;
when both match as a result of said comparison, generating a content key from said key management information by using its own device key; and
encrypting input content data by using said generated content key and recording the obtained encrypted content data on said third read-only area.

13. A method of producing information recording medium, comprising:
preparing an information recording medium having a first read-only area recording a specified key management information, a second read-only area recording compressed data comprising said key management information compressed with a specified function according to a recording system different from that for said first read-only area, and a third read-only area capable of only once recording encrypted content data resulting from encryption based on said key management information;
reading key management information from said first read-only area on said prepared information recording medium and converting said key management information to compressed data by using a specified function;
reading compressed data from said second read-only area and comparing this compressed data with the compressed data obtained at said conversion;
when both match as a result of said comparison, generating a content key from said key management information by using its own device key; and
encrypting input content data by using said generated content key and recording the obtained encrypted content data on said third read-only area.

14. A method of playing information from an information recording medium, comprising:
preparing an information recording medium having a first read-only area recording a specified key management information, a second read-only area recording compressed data comprising said key management information compressed with a specified function according to a recording system different from that for said first read-only area, and a third read-only area recording encrypted content data resulting from encryption based on said key management information;
reading key management information from said first read-only area on said information recording medium and converting said key management information to compressed data by using a specified function;
reading compressed data from said second read-only area and comparing this compressed data with the compressed data obtained at said conversion;
when both match as a result of said comparison, generating a content key from said key management information by using its own device key; and
reading said encrypted content data from said third read-only area, decrypting said encrypted content data by using said generated content key, and outputting obtained content data.

15. An information recording medium comprising:
a first read-only area recording specified key management information;
a second read-only area recording compressed data comprising said key management information compressed with a specified function according to a recording system different from that for said first read-only area; and
a third read-only area for only once recording encrypted content data resulting from encryption based on said key management information.

16. The information recording medium according to claim 15, wherein said first read-only area is arranged in between said second read-only area and said third read-only area.

17. The recording apparatus for recording information on the information recording medium described in claim 15, comprising:
a compression circuit configured to convert key management information read from a first read-only area on said information recording medium to compressed data by using a specified function;
a comparison circuit configured to compare compressed data read from a second read-only area on said information recording medium with compressed data obtained in said compression circuit;
a key generation circuit configured to generate a content key from said key management information by using its own device key when a match is found as a result of comparison by said comparison circuit; and
an encryption recording circuit configured to encrypt input content data by using a content key generated in said key generation circuit and record obtained encrypted content data onto said third read-only area.

18. The playback apparatus for playing information from the information recording medium described in claim 15, comprising:
a compression circuit configured to convert key management information read from a first read-only area on said information recording medium to compressed data by using a specified function;
a comparison circuit configured to compare compressed data read from a second read-only area on said information recording medium with compressed data obtained in said compression circuit;
a key generation circuit configured to generate a content key from said key management information by using its own device key when a match is found as a result of comparison by said comparison circuit; and
a decryption circuit configured to decrypt encrypted content data read from a third read-only area on said information recording medium by using a content key generated in said key generation circuit and output obtained content data.

19. An information recording medium comprising:
a first read-only area recording specified key management information;
a second read-only area recording compressed data comprising said key management information compressed with a specified function according to a recording system different from that for said first read-only area; and
a third read-only area recording encrypted content data resulting from encryption based on said key management information.

20. An information recording medium comprising:
a first read-only area recording specified key management information, wherein said key management information, after it is read, is used as compressed data converted with a specified function and is compared to compressed data in said second read-only area.
a second read-only area recording compressed data comprising said key management information compressed with a specified function according to a recording system different from that for said first read-only area; and
a third read-only area for recording encrypted content data based on said key management information when said comparison results in a match.
